(19) United States
(12) Patent Application Publication
(10) Pub. No.: US 2013/0100438 A1
(43) Pub. Date: Apr. 25, 2013

(54) Method and Apparatus for Detecting a Vehicle Movement

(71) Applicants: Karsten Breuer, Lauenau (DE); Bijan Gerami-Manesch, Burgdorf (DE); Daniel Hanslik, Isernhagen (DE); Guido Hoffmann, Burgwedel (DE); Dirk Sandkuhler, Seelze (DE)

(72) Inventors: Karsten Breuer, Lauenau (DE); Bijan Gerami-Manesch, Burgdorf (DE); Daniel Hanslik, Isernhagen (DE); Guido Hoffmann, Burgwedel (DE); Dirk Sandkuhler, Seelze (DE)

(73) Assignee: WABCO GmbH, Hannover (DE)

(21) Appl. No.: 13/807,199

(22) PCT Filed: Jun. 10, 2011
(86) PCT No.: PCT/EP11/02854

§ 371 Date: Dec. 27, 2012

(30) Foreign Application Priority Data
Jun. 30, 2010 (DE) 102010025706.0
Mar. 30, 2011 (DE) 102011015457.4

(51) Int. Cl. G01B 11/14

(52) U.S. Cl. CPC G01B 11/14
USPC 356/51; 356/614

(57) ABSTRACT

The description relates to a method and a motion sensor for detecting a vehicle movement with respect to a subsurface. The motion sensor comprises a light source unit (12) for emitting light of at least one wavelength onto the subsurface (1), at least one detector (22) for detecting light reflected by the subsurface, and an evaluation device (50) for detecting a change in the intensity of the detected reflected light over time.

The present invention relates to a method and an apparatus for recognizing a vehicle movement in relation to an underlying surface. The present invention relates in particular to an optical method for registering a movement of a vehicle in relation to an underlying surface and to a corresponding optical movement sensor.

Speedometers are typically used in order to establish automatically whether a vehicle is currently moving or whether the vehicle is stationary. These systems are usually based on the principle of measuring the rotational velocity of a vehicle wheel. Such velocity sensors can be implemented solely mechanically, but currently typically operate in a contactless manner using inductive or Hall sensors. Velocity sensors can be attached to each wheel, as is typical in ABS systems, for example.

For example, DE 198 38 885 A1 describes such a method and an apparatus for ensuring the stoppage of a vehicle, in which a parking brake is activated or an automatic transmission is shifted into the park position after recognized stoppage. The determination of the vehicle movement is performed via speedometers and other sensors, as are provided in devices for adaptive speed regulation.

Determining a vehicle movement via the change of corresponding GPS data is also known. EP 1 606 784 B1 describes a sensor for recognizing road states, wherein multiple sensors are networked in a system and, inter alia, the position of the sensors can be determined, e.g., by means of GPS.

However, all of these systems have the disadvantage that they only reliably function at higher velocities, and are typically not capable of establishing whether a vehicle is stationary or is still moving at low velocity, for example, at walking velocity or slower.

Furthermore, systems for optical registrations of movements of a vehicle are known from DE 44 09 241 and DE 44 44 223 A1, in which the underlying surface is imaged on a photo receiver array designed as a grid. By ascertaining an optical cross-correlation of the images thus registered, the movement direction and velocity are optically determined.

However, the known velocity sensors are imprecise above all at low velocities, so that slow rolling of the vehicle often cannot be differentiated from a stoppage. The present invention is therefore based on the object of providing a sensor and a method, using which a movement or the stoppage, respectively, of a vehicle can be recognized more reliably and easily.

This object is achieved by a method and a sensor for registering a vehicle movement in relation to an underlying surface according to claim 1 and by a movement sensor according to claim 6.

The method comprises emitting at least one light beam onto the underlying surface, detecting light reflected on the underlying surface, and ascertaining whether the intensity of the reflected light changes in a predetermined time interval within a predetermined variance of the intensity. The light intensity can be measured with interruptions, at intervals, or uninterrupted over a predetermined time interval. If the vehicle is not moving, the change of the light intensity of the reflected light remains within the predetermined variance. If the vehicle is moving, the change of the light intensity of the reflected light is increased and exceeds the predetermined variance. The variance can be predetermined so that the change of the light intensity is within the variance when the vehicle is stationary. Because of the high time resolution, a vehicle movement can be established even if it is very slow, for example, less than 1 m/s or less than 0.1 m/s.

The detection of light reflected on the underlying surface can particularly comprise diffusely reflected light. In this way, the susceptibility to interference of the system can be reduced still further, in particular if a compensation is performed with respect to different reflected light, or if supplementary registrations are provided, or boundary conditions are known in another manner, respectively.

The emission of the light beam onto the underlying surface can comprise light of one or more wavelengths in the infrared range. However, light in the visible range can also be used. The use of determined wavelengths can take into consideration the external circumstances in this regard, wherein multiple wavelengths can in turn reduce the susceptibility to interference.

An optical surface sensor, which is also designed for the purpose of registering the intensity of reflected light over time, can advantageously also be used to determine the vehicle movement. Therefore, practically no additional costs result for the integration.

The movement sensor according to the invention comprises a light source unit for emitting light of at least one wavelength onto the underlying surface, at least one detector for detecting light reflected from the underlying surface, and a registration unit for registering a change of the intensity of the detected reflected light over time.

The movement sensor can particularly also be a surface sensor, which additionally has the registration unit for registering the intensity change of the detected light. The registration unit can be integrated in a control unit of the surface sensor or can be implemented as an additional unit. An already provided surface sensor can thus optionally be expanded with the additional function of a movement sensor or repurposed thereto.

The light source unit can comprise one or more light sources. At least one of the light sources can be an infrared light source. Light of one wavelength is sufficient for the movement sensor. There can also be multiple infrared light sources, in particular three infrared light sources for emitting infrared light of three different wavelengths. Infrared light has the advantage that it cannot be perceived by people.

The light source unit and the at least one detector of the movement sensor can be arranged in a housing in direct proximity to one another or adjacent to one another. Furthermore, the movement sensor can be designed for the purpose of being arranged on a vehicle or being installed subsequently thereon in such a manner that an optical emitter axis of the light source unit is aligned substantially perpendicular to the underlying surface under the vehicle. An optical detector axis of the at least one detector can also be arranged substantially perpendicular to the underlying surface, so that the optical emitter axis and the optical detector axis are arranged substantially parallel to one another and/or superimposed on one another. Light reflected by essentially 180°, in particular light reflected at an angle of 170° to 190° is therefore detected.

The movement or the movement sensor according to the invention, respectively, allow it to be recognized whether the vehicle is moving or stationary in relation to the underlying surface. An actual stoppage of the vehicle can be used for the purpose, for example, of determining zero positions of sensors of driver assistance systems, in particular yaw rate sensors for ESC, ACC systems, etc., or allowing a recalibration. If a vehicle stoppage has been registered, a brake, e.g., an electropneumatic parking brake, can optionally also be engaged. Alternatively or additionally, a warning can be output to the driver if the vehicle begins to move while the engine is not turned on, for example. Furthermore, the stoppage sensor can also be combined with door locking or unlocking mechanisms, so that it is only possible to unlock the doors when the vehicle is actually at a stop. This can be applied in particular in vehicles for passenger transport.

The movement sensor can comprise a second detector and optionally further detectors in addition to the first detector.

Further details and examples of the invention are specified hereafter with reference to the appended figures solely as examples and in a nonrestrictive manner. In the figures:

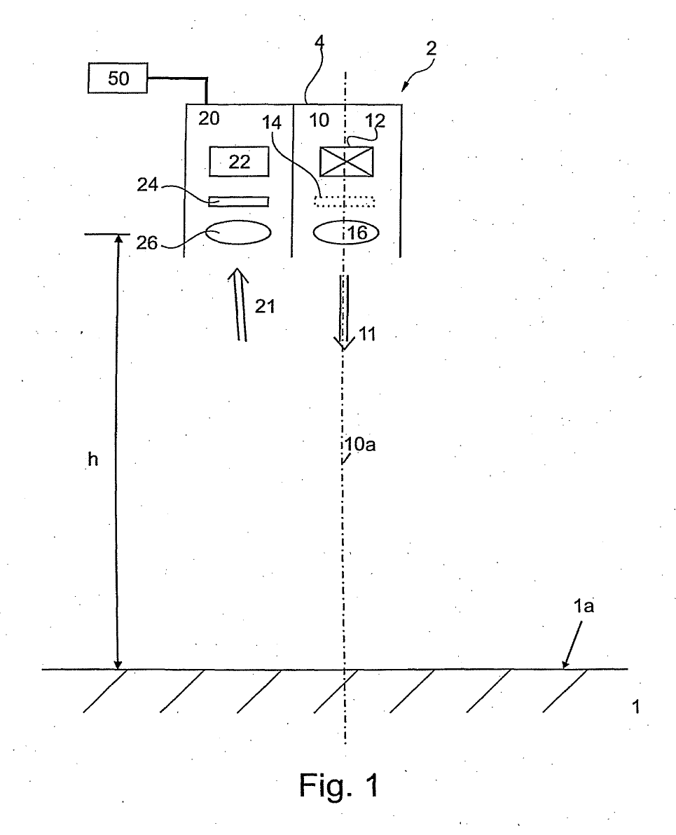

FIG. 1 shows a schematic illustration of a movement sensor having a detector;

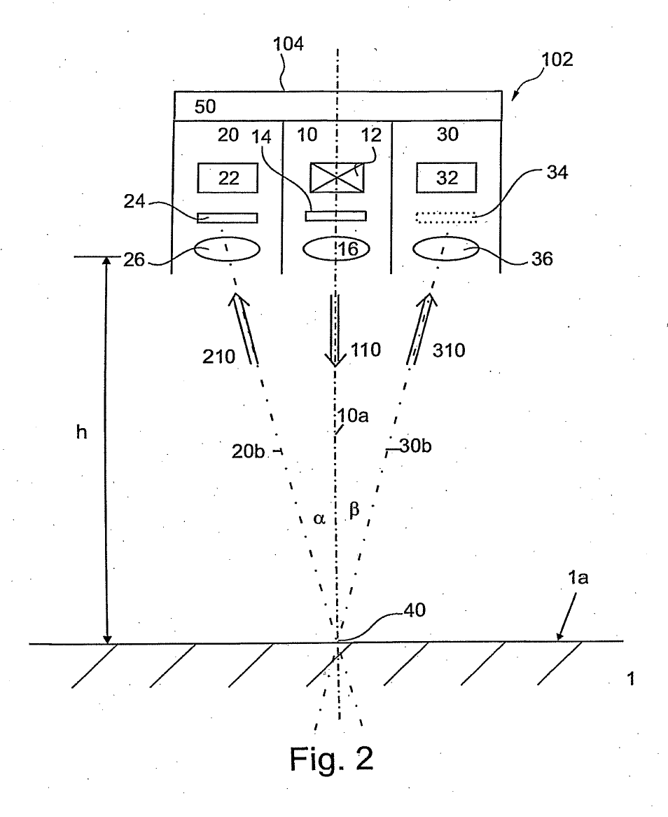

FIG. 2 shows a schematic illustration of a movement sensor having two detectors;

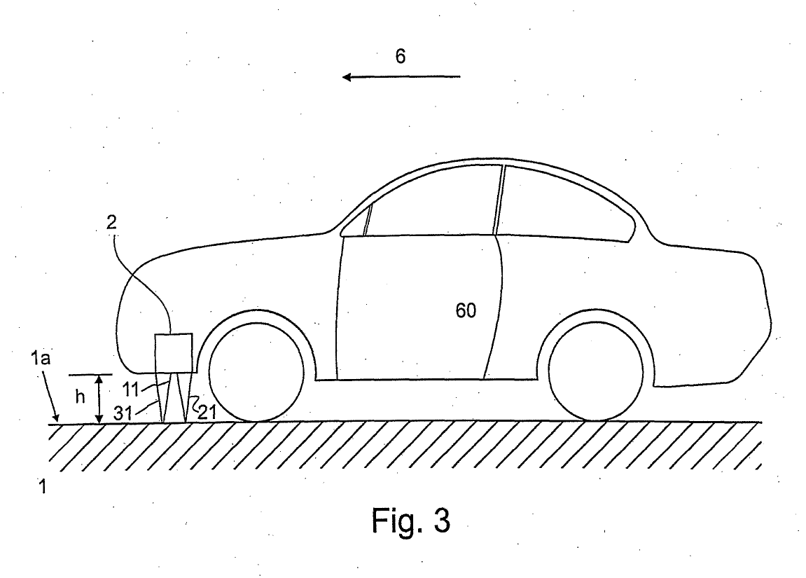

FIG. 3 shows the arrangement of a movement sensor on a vehicle; and

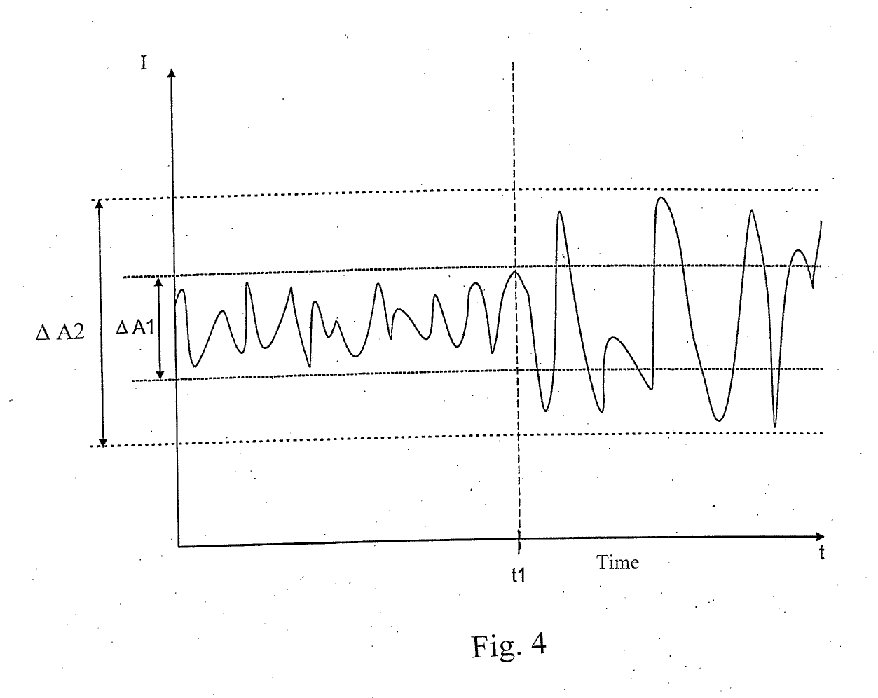

FIG. 4 shows an example of an intensity signal.

FIG. 1 schematically shows an example of the structure of a sensor for detecting a movement or a stoppage, respectively, of a vehicle. The sensor 2 has a light emitter unit 10 and at least one first detector unit 20. The light emitter unit 10 and the first detector unit 20 and optionally further detector units can be arranged, as shown, in a shared housing 4 of the sensor 2. The sensor 2 can be constructed very compactly and can also easily be installed subsequently on a vehicle 60 through the arrangement of the light emitter unit 10, the first detector unit 20, and optionally further detector units in a housing 4. The light emitter unit 10 and the first detector unit 20 can also be arranged in separate housings and at different points, however.

The sensor 2 comprises a light emitter unit 10 having a light source unit 12, which can comprise one or more light sources. The light source unit 12 is capable of emitting light of at least one wavelength, preferably in the infrared range. The light source unit 12 can comprise one or more light emitting diodes (LEDs), laser diodes, another suitable light source, or a combination thereof. The light emitter unit 10 comprises an emitter optic 16, which is arranged so that the light emitted by the light source unit 12 is aligned or focused, respectively, along an emitted light beam 11 onto a specific region on the underlying surface or the roadway 1 or the roadway surface 1a under the vehicle 60. The optical axis of the emitter optic 16 can define the light emitter axis 10a of the light emitter unit 10. The emitter optic 16 can consist of one emitter lens or can comprise multiple lenses and/or other optical elements. A light source polarizer or a light source polarization filter 14 can optionally be provided on the light emitter unit 10. The light source polarizer 14 is used for the purpose of polarizing the light emitted by the light source unit 12 in a predetermined direction.

The sensor 2 also comprises, in the first detector unit 20, a first detector 22, for example, one or more photodiodes, which are designed for the purpose of detecting light of all wavelengths emitted by the light source unit 10. The first detector 22 can also comprise multiple photodiodes arranged adjacent to one another and/or one or more optoelectronic units (e.g., CCD, CMOS) for this purpose. The first detector unit 20 also comprises a first converging optic 26 and a first polarization filter 24. The first converging optic 26 can consist of a single first converging lens or can comprise multiple lenses and/or further optical elements or a combination thereof. The first converging optic 26 is used for the purpose of focusing light reflected on the roadway surface 1a onto the first detector 22.

The first polarization filter 24 is used for the purpose of filtering out specularly reflected light which is polarized in the predetermined direction, so that only diffusely reflected light reaches the first detector 22. The polarization direction of the first polarization filter 24 is aligned perpendicular to that of the light source polarizer 14 and therefore substantially perpendicular to the predetermined polarization direction.

A first axis 20a can substantially correspond to the optical axis of the first converging optic 26 and/or the first detector unit 20 and can be aligned substantially parallel to the emitter axis 10a, which substantially corresponds to the optical axis of the emitter optic 16 and/or the light emitter unit 10.

The sensor 2 can be implemented solely as a movement sensor. However, it can also be provided that the sensor is simultaneously also used as a surface sensor for registering a condition or type or a state, respectively, of the roadway surface 1a. For this purpose, the sensor can be operated at various wavelengths in the infrared range. For example, infrared light of the wavelength 1460 nm is absorbed particularly well by water, so that light of this wavelength is only reflected back to a small extent to the first detector 22 or the second detector 32, respectively, in the event of a wet roadway. In the event of a dry roadway, in contrast, this wavelength is reflected normally. Infrared light of the wavelength 1550 nm is absorbed well by ice, in contrast. By comparing the reflection of these two wavelengths and considering a reference wavelength, the presence of ice or water on the roadway can be concluded. The reference wavelength, which is not noticeably absorbed by ice or water, e.g., 1300 nm, is used as the reference variable for evaluating the degree of absorption of the two other wavelengths. The measured intensity ratios at the wavelengths 1550 nm/1300 nm can then be related to the ratio 1460 nm/1300 nm in a known manner, to obtain information about water and ice on the roadway or a dry roadway.

The various wavelengths can be emitted in parallel, but particularly sequentially offset. Therefore, only light of one wavelength is emitted at a point in time and accordingly detected in each case. This allows complex spectral analysis or beam splitting to be omitted.

The method or the sensor is fundamentally also conceivable employing other wavelengths, but infrared light offers the advantage here that it cannot be perceived by the human eye.

In addition, the sensor can have further detector units. Such a combined surface and movement sensor 102 having two detectors is shown in FIG. 2. In addition to the features of the sensor 2 described with reference to FIG. 1, the surface and movement sensor 102 can have at least one second detector unit 30, wherein the housing 104 is adapted accordingly and the second detector unit is received in the housing 104. The second detector unit 30 has a second detector 32 and a second converging optic 36 and is used for the purpose of focusing specularly reflected light and diffusely reflected light by means of the converging optic 36 on the second detector 32.

The second detector unit 30 can optionally have a second polarization filter 34, whose polarization direction is substantially perpendicular to the first polarization direction of the first polarization filter 24.

The described sensor 102 can be operated in the visible light range, for example, at a wavelength of approximately 625 nm, to measure specularly reflected light and diffusely reflected light. The roadway brightness or the roadway roughness, respectively, can be concluded from the ratio of diffusely reflected light measured in the first detector 22 to the specularly reflected light additionally measured in the second detector 32 and it can therefore be determined whether the vehicle is located on an asphalt or concrete roadway, for example. However, infrared light can also be used, for example, the above-mentioned reference wavelength can be used.

The functional principle of such surface sensors 102, which compare specularly reflected light and diffusely scattered light to one another or set them in a ratio to one another, is known in the prior art. The surface sensor 102 can additionally also be operated in a spectral manner using at least two, in particular three different wavelengths, e.g., in the infrared range, as described above with reference to FIG. 1.

The sensor 2, 102 also has an analysis unit 50, using which the data registered or ascertained by the first detector 22 and optionally a second detector 32 can be processed. The analysis unit 50 can be arranged outside the housing 4, 104 and can be located at another point in the vehicle 60, for example, as shown in FIG. 1. The analysis unit 50 can be connected to the first detector 22 and the second detector 32 via a cable or a wireless connection. Alternatively, the analysis unit 50 can also be arranged inside the housing 4, 104, as shown as an example in FIG. 2.

The analysis unit can also comprise a controller for the light source unit 21 or can be connected to a controller. The analysis unit 50 and/or the controller can also be arranged on or in the housing 4, 104 or integrated therein, however, as shown with reference to FIG. 2.

The analysis unit 50 is particularly designed for the purpose of registering the light intensity of the diffusely reflected light registered in the first detector 22 and/or the reflected light registered in the second detector 32 over time and determining whether the light intensity changes more than in a predefined variance or variation range. The analysis unit 50 can also be the analysis unit of a sensor 102, if the sensor 102 is operated as a surface sensor.

FIG. 3 shows how the sensor 2 from FIG. 1 or the sensor 102 from FIG. 2, respectively, can be arranged on a vehicle 60. To register the vehicle movement 6 or the vehicle stoppage, respectively, the sensor 2, 102 can be arranged at any arbitrary point on the underside of the vehicle 60. However, it can be advantageous to arrange the movement sensor 2, 102 at a specific point of the vehicle 60.

The sensor 2, 102 is arranged on the vehicle 60 so that the emitted light beam 11 or the emitter axis 10a, respectively, is aligned substantially perpendicular to the roadway surface 1a, i.e., the light beam 11a emitted by the light source unit 10 is incident substantially at a right angle on the roadway surface 1a and is reflected thereon. The reflected light is reflected by essentially 180°, in particular at an angle α,β of approximately 170° to 190° and a first reflected light beam 21 is detected by the first detector unit 20 and a second reflected light beam 31 is optionally detected by the second detector unit 30.

In the example shown in FIG. 2, the first axis 20b, which can correspond to the optical axis of the first converging optic 26 and/or of the entire first detector section 20, is aligned at an angle α to the emitter axis 10a, wherein the angle α is at most approximately 10°. Correspondingly, the second axis 30b, which can correspond to the optical axis of the second converging optic 36 and/or of the entire second detector section 30, is aligned at an angle β to the emitter axis 10a, wherein the angle β is also at most approximately 10°. The point of intersection 40 of the emitter axis 10a with the first axis 20b and/or the second axis 30b can lie on the roadway surface 1a or can lie at a distance of up to 50 cm from the roadway surface 1a.

The sensor 2, 102 and particularly the emitter optic 16 and the first converging optic 26 or optionally also the second converging optic 36, respectively, can be designed for the purpose of being arranged at a specific height or a specific height range over the roadway surface 1a. For example, the sensor 2, 102 can be designed for the purpose of being arranged at a height h or a distance of approximately 10 cm to approximately 1 m from the roadway surface 1a, wherein the distance can be adapted to a respective intended purpose. The height h can be in the range of approximately 10 cm to 40 cm for the use of the sensor 2, 102 in a passenger automobile. In the event of a use of the sensor 2, 102 in a utility vehicle or an off-road vehicle, the height h can be approximately 30 cm to approximately 100 cm, in particular in a range from 50 cm to 80 cm.

A method for measuring the stoppage or a movement, respectively, of a vehicle 60 comprises emitting light by means of the light emitter unit 12, for example. The light can be emitted continuously or in pulses. The light emitted and reflected on the road surface 1a is then registered by means of the first detector unit 20, for example, and the intensity of the registered light is determined. The light incident on the first detector unit 20 can be detected continuously or only at points in time or periods of time when light of the corresponding wavelength is emitted from the light source unit 12. For example, the light intensity can also be registered when no light is emitted from the light source unit 12, so that light emitted from other light sources or infrared radiation emitted from the road surface 1a, respectively, can be recognized as background radiation. This background radiation can then optionally be subtracted from the registered values to avoid or decrease measuring errors.

The light registered by the first detector unit 20 or the measured light intensity, respectively, is correlated with respect to time to the emitted light and measured over a specific time interval. An example of the light intensity measurement is shown in FIG. 4. The time interval can be a single light pulse approximately 0.04 seconds long or can be averaged over multiple light pulses.

In order to now detect a movement of the vehicle, the “noise” of the received measured signal is interpreted as illustrated as an example in FIG. 4. For this purpose, the standard deviation can be determined separately in a running manner for each of the received wavelengths. The number of values which are used for this calculation can be determined beforehand (e.g.: 40 values every 30 ms). The calculated standard deviations are subsequently compared to a previously fixed threshold value. If all three standard deviations are less than this threshold value, stoppage of the vehicle is concluded.

If the vehicle 60 is stationary, the reflection characteristic of the underlying surface does not change. Therefore, the intensity I of the reflected light, i.e., the light which is incident on the first detector unit 20, also does not change and the intensity variations remain within a variation interval, which is determined by the sensor structure, for a stationary vehicle ΔA1. As long as the intensity variation remains within this variation interval for a stationary vehicle ΔA1, the vehicle 60 is not moving. An example of a corresponding intensity signal is shown before the point in time t1 in FIG. 4. However, if the vehicle 60 is moving, even slowly, for example, at a velocity in the range of approximately 0.1 to 3 km/h, the detected light intensity I of the first reflected light beam 21 and/or the second reflected light beam 31 changes more strongly, due to the differing reflection of the emitted light on the roadway surface 1a, and has a variation interval for a traveling vehicle ΔA2, which is greater than the variation interval for a stationary vehicle ΔA1. An example of a corresponding intensity signal is shown after the point in time t1 in FIG. 4. Therefore, a variation interval or a variance or a threshold value, respectively, can be provided, which allows a differentiation between a vehicle movement 6 and the absolute vehicle stoppage. It is therefore possible to register vehicle movements 6 of less than 3 km/h or 1 m/s. For example, it is also possible to register vehicle velocities in the range of approximately 0.1 m/s or less. The sensor 2, 102 can have a control unit 52 for registering the vehicle movement. This control unit 52 can be comprised in an analysis unit 50 for the surface sensor or can be additionally attached to the sensor, so that a commercially-available surface sensor can be supplemented and/or retrofitted to form a movement sensor 2, 102 according to the present invention.

The movement sensor 2, 102 of the present description can also be designed for retrofitting on existing vehicles 60. For example, a warning signal or a warning lamp can indicate when the vehicle 60 is moving.

Notwithstanding this, the obtained information about whether the vehicle 60 is moving or stationary can be used for the purpose of calibrating a driver assistance systems sensor, for example, a sensor of a stability program, in particular in regard to the correct zero position of the yaw rate signal.

The sensor 2, 102 and the information as to whether the vehicle 60 is moving or stationary can also be used for the purpose of activating an electrical or pneumatic parking brake and/or activating or deactivating a door unlocking or locking mechanism. In particular, it can be provided that opening doors is only permitted in vehicles for passenger transport, such as omnibuses or rail vehicles, when the vehicle is actually stationary, to avoid accidents. Further applications, which use the information about the movement or the stoppage, respectively, of the vehicle are routine to a person skilled in the art.

The preceding description was provided in regard to the examples shown in FIGS. 1 to 4. However, a person skilled in the art will readily modify or combine the indicated example and supplement it with further optical modifications, for example, further wavelengths or filters, in order to improve the sensor accordingly. A person skilled in the art will also consider wavelengths other than those indicated to adapt the measurement results to different requirements.

It is obvious that the specified wavelengths are not restricted to precisely these values, but rather can comprise a wavelength range which contains the specified discrete wavelengths.

1. A method for registering a vehicle movement in relation to an underlying surface (1), wherein the method comprises:
emitting at least one light beam (11) onto the underlying surface (1);
detecting light (21) reflected on the underlying surface (1); and
ascertaining whether the light intensity of the reflected light changes in a predetermined time interval within a predetermined variance.

2. The method as claimed in claim 1, wherein the light beam is emitted substantially perpendicular to the underlying surface.

3. The method as claimed in one of the preceding claims, wherein the reflected light comprises diffusely reflected light.

4. The method as claimed in one of the preceding claims, wherein the emission of the light comprises light of multiple wavelengths in the infrared range.

5. A use of an optical surface sensor for determining a vehicle movement.

6. A movement sensor (2, 102) for registering a vehicle movement in relation to an underlying surface (1), wherein the movement sensor (2, 102) comprises:
a light source unit (12) for emitting light of at least one wavelength onto the underlying surface (1),
at least one detector (22) for detecting light reflected from the underlying surface, and
an analysis unit (50) for registering a change of the intensity of the detected reflected light over time.

7. The movement sensor (2, 102) as claimed in claim 6, which is also a surface sensor.

8. The movement sensor (2, 102) as claimed in claim 6 or 7, wherein the light source unit (12) comprises at least one infrared light source, in particular multiple infrared light sources.

9. The movement sensor (2, 102) as claimed in one of claims 6 to 8, wherein an optical detector axis (20a, 30a) of the at least one detector (22, 32) and an optical emitter axis (10a) of the light source unit (12) are arranged substantially parallel to one another and/or superimposed on one another.

10. The movement sensor as claimed in one of claims 6 to 9, which is designed to carry out the method as claimed in one of claims 1 to 8.
